(19) United States
(12) Patent Application Publication
(10) Pub. No.: US 2015/0117310 A1
(43) Pub. Date: Apr. 30, 2015

(54) METHOD AND APPARATUS TO ROUTE PACKET FLOWS OVER TWO TRANSPORT RADIOS

(71) Applicants: Li Zexian, Espoo (FI); Cassio Ribeiro, Espoo (FI); Esa Malkarnaki, Espoo (FI); Mikko Uusitalo, Helsinki (FI); Antti Sorri, Helsinki (FI)

(72) Inventors: Li Zexian, Espoo (FI); Cassio Ribeiro, Espoo (FI); Esa Malkarnaki, Espoo (FI); Mikko Uusitalo, Helsinki (FI); Antti Sorri, Helsinki (FI)

(73) Assignee: NOKIA CORPORATION, Espoo (FI)

(21) Appl. No.: 14/394,303

(22) PCT Filed: Apr. 27, 2012
(86) PCT No.: PCT/US2012/035653

§ 371 Date: Jan. 9, 2015

(51) Int. Cl. H04W 40/02

(52) U.S. Cl. CPC H04W 40/02
USPC 370/328

(57) ABSTRACT

In accordance with an example embodiment, a method is provided comprising receiving packets of at least one flow in a packet switching function, and based on at least one criterion, deciding in the packet switching function on switching the packets to one or both of a cellular transport radio and a wireless local area network transport radio. In some embodiments, the packet switching function is disposed in a protocol stack between a radio link control protocol layer and a medium access control protocol layer.

### TECHNICAL FIELD

The exemplary and non-limiting embodiments of this invention relate generally to wireless communication systems, methods, devices and computer programs and, more specifically, relate to traffic switching between a cellular radio and a another radio, where the cellular radio can be compliant with, for example, LTE/LTE-A and the other radio can be compliment with, for example, WiFi.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in the application and is not admitted to be prior art by inclusion in this section.

The following abbreviations that may be found in the specification and/or the drawing figures are defined as follows:
3GPP third generation partnership project
Wi-Fi Wireless Fidelity, the wireless local area network (WLAN) technology based on the IEEE 802.11 standard. IEEE 802.11 covers technologies certified as IEEE 802.11a/b/g/n/ac/ad/af/s/i/v for example.
AP Wi-Fi access point
APN access point name
DHCP dynamic host configuration protocol
eNB evolved NodeB, base station in a LTE/LTE-A network
EPS evolved packet system
GTP general packet radio service (GPRS) tunnel protocol
GTP-u GTP tunnel for user plane traffic
LTE Long Term Evolution, a technology standardized by 3GPP
LTE-A LTE-Advanced, a technology evolution step of LTE standardized by 3GPP
NAS non-access stratum
PDCP packet data convergence protocol
PDN GW packet data network gateway, a gateway in a mobile operator's network to service network connectivity of a UE
SDU service data unit
STA WiFi station
TEID tunnel endpoint identifier of the GTP-u tunnel
UE user equipment, e.g., a cellular phone, smart phone, computing device such as a tablet
USIM universal subscriber identity module

Additional abbreviations that may appear in the description or drawings include:
ARQ automatic repeat request
DL downlink (eNB towards UE)
eNB E-UTRAN Node B (evolved NodeB)
EPC evolved packet core
E-UTRAN evolved UTRAN (LTE)
GGSN gateway GPRS support node
GPRS general packet radio service
HARQ hybrid automatic repeat request
IMTA international mobile telecommunications association
ITU-R international telecommunication union-radiocommunicator sector
MAC medium access control (layer 2, L2)
MM/MMB mobility management/mobility management entity
OFDMA orthogonal frequency division multiple access
O&M operations and maintenance
PCRF policy charging and rules function
PDCP packet data convergence protocol
PHY physical (layer 1, L1)
Rel release
RLC radio link control
RRC radio resource control
RRM radio resource management
SGSN serving GPRS support node
S-GW serving gateway
SC-FDMA single carrier, frequency division multiple access
UL uplink (UE towards eNB)
UPE user plane entity
UTRAN universal terrestrial radio access network

One modem communication system is known as evolved UTRAN (E-UTRAN, also referred to as UTRAN-LTE or as E-UTRA).

One specification of interest is 3GPP TS 36.300 V 10.5.0 (2011-09) Technical Specification 3^{rd} Generation Partnership Project; Technical Specification Group Radio Access Network: Evolved Universal Terrestrial Radio Access (E-UTRA) and Evolved Universal Terrestrial Radio Access Network (E-UTRAN); Overall description; Stage 2 (Release 10) referred to for simplicity hereafter as 3GPP TS 36.300.

FIG. 1A reproduces FIG. 4.1 of 3GRP TS 36.300 and shows the overall architecture of the EUTRAN system (Rel-8). The E-UTRAN system includes eNBs, performing functions of base stations, providing the E-UTRAN user plane (u-Plane, PDCP/RLC/MAC/PHY) and control plane (c_Plane, RRC) protocol terminations towards the UEs. The eNBs arc interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a marry-to-marry relationship between MMEs/S-GWs/UPEs and eNBs.

The eNB hosts the following functions:

functions for RRM; RRC, Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the EPC (MME/S-GW);
scheduling and transmission of paging messages (originated from the MME);
scheduling and transmission of broadcast information (originated from the MMB or O&M); and
a measurement and measurement reporting configuration for mobility and scheduling.

Also of interest herein are the further releases of 3GPP LTE (e.g., LTE Rel-10) targeted towards future IMT-A systems, referred to herein for convenience simply as LTE-Advanced (LTE-A).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimised radio system fulfilling the ITU-R requirements for IMT-Advanced while keeping the backward compatibility with LTE Rel-8.

Section 4.3.1 of 3GPP TS 36.300, entitled User plane, shows in FIG. 4.3.1-1: user-plane protocol slack (reproduced herein as FIG. 1B), the protocol stack for the user-plane, where PDCP, RLC and MAC sublayers (terminated in the eNB on the network side) perform the functions listed for the user plane in subclause 6, e.g. header compression, ciphering, scheduling, ARQ and HARQ. These protocols also serve the transport of the control plane.

Section 4.3.2 of 3GPP TS 36.300, entitled Control plane, shown in FIG. 4.3.2-1 the control-plane protocol stack (reproduced herein as FIG. 1C), where the PDCP sublayer (terminated in the eNB on the network side) performs the functions listed for the control plane in subclause 6, e.g. ciphering and integrity protection. The RLC and MAC sublayers (terminated in the eNB on the network side) perform the same functions as for the user plane, the RRC (terminated in the eNB on the network side) performs the functions listed in subclause 7, e.g.; Broadcast; Paging; RRC connection management; RB (radio bearer) control; Mobility functions; and UE measurement reporting and control. The NAS control protocol (terminated in the MME on the network side) performs among other things: EPS bearer management; Authentication; ECM-IDLE mobility handling; Paging origination in ECM-IDLE; and Security control.

One benefit of switching, or offloading, 3GPP LTE traffic to Wi-Fi is the availablility of large amounts of license-exempt band frequencies for the traffic.

A problem that is encountered when considering offloading 3GPP LTE traffic to Wi-Fi is that LTE and Wi-Fi are different kinds of radios and, in addition, they use network connectivity protocols in different ways.

Even if Wi-Fi is used hereto describe a wireless local area network, it may be possible to have another local area radio working in this type of a role. It is foreseen that 3GPP in the future may define an evolved local area radio technology that is compatible to the LTE/LTE-A radio interface but operates otherwise in a similar role as Wi-Fi.

This kind of an evolved local area radio may use a license-exempt frequency band, as in Wi-Fi, but it may as well be designed to use other bands, currently not available to cellular operators, such as spectrum bands that will become available via authorized shared access principles, cognitive radio principles, flexible spectrum use principles and principles applicable to use of white spaces (e.g., unused spectrum between broadcast media hands), or any other new spectrum that becomes locally available. These kinds of opportunities for new spectrum for local use may actually make available large-amounts of spectrum that would otherwise not be available for communications, and possibly for other purposes of spectrum use.

### SUMMARY

The foregoing and other problems are overcome, and other advantages are realized, by the use of exemplary embodiments of the invention.

According to a first aspect of the present invention, there is provided a method, comprising receiving packets of at least one flow in a packet switching function, and based on at least one criterion, deciding in the packet switching function on switching the packets to one or both of a cellular transport radio and a wireless local area network transport radio.

According to a second aspect of the present invention, there is provided an apparatus, comprising at least one data processor, at least one memory including computer program code, where the at least one memory and computer program code are configured, with the at least one data processor, to cause the apparatus at least to receive packets of at least one flow in a packet switching function, and based on at least one criterion, decide in the packet switching function on switching the packets to one or both of a cellular transport radio and a wireless local area network transport radio.

According to a third aspect of the present invention, computer programs are provided, which may be stored on non-transitory computer-readable media, configured to cause methods according to various aspects of the present invention to be performed, when run.

### BRIEF DESCRIPTION OF THE DRAWINGS

In the attached Drawing Figures:

FIG. 1A reproduces FIG. 4.1 of 3GPP TS 36.300, and shows the overall architecture of the EUTRAN system.

FIG. 1E reproduces FIG. 4.3.1-1. of 3GPP TS 36,300, and shows the user-plane protocol stack.

FIG. 1C reproduces FIG. 4.3.2-1 of 3GPP TS 36.300, and shows the control-plane protocol stack.

FIG. 2 shows a simplified block diagram of various electronic devices that are suitable for use in practicing example embodiments of this invention.

FIG. 3 illustrates an example protocol stack in accordance with at least some embodiments of the invention.

FIG. 4 illustrates signaling related to at least some embodiments of the invention.

FIG. 5 illustrates signaling related to at least some embodiments of the invention involving a quality-of-service tag.

FIG. 6 is a flow diagram of a method in accordance with at least some embodiments of the invention.

### DETAILED DESCRIPTION

Traffic flow is typically identified by a Source address and a Destination address of the Internet Protocol, by a Destination and/or a Source port and by a traffic class or a differentiated services code point (6-bit DSCP field in an IP header). In at least some embodiments of this invention these and any other methods of assigning a flow may be applied.

The offloading of 3GPP network traffic to Wi-Fi is considered beneficial and therefore several offloading architectures, scenarios and solutions are defined and standardized by the 3GPP SA2 since LTE R-8 and up to Rel-11.

The conventional approaches do not apply any standardized mechanism to control the offload radio at the radio access network level.

For example, 3GPP TS 29.060 V11.0.0 (2011-09) Technical Specification 3^{rd} Generation Partnership Project; Technical Specification Group Core Network and Terminals; General Packet Radio Service (GPRS); GPRS Tunneling Protocol (OTP) across the Gn and Gp interface (Release 11) discusses in Section 9 the GTP-U and in Section 9.1 the GTP-U Protocol Entity as follows.

The GTP-U protocol entity provides packet transmission and reception services to user plane entities in the GGSN, in the SGSN and, in TMTS systems, in the RNC. The GTP-U protocol entity receives traffic from a number of GTP-U tunnel endpoints and transmits traffic to a number of GTP-U tunnel endpoints. There is a GTP-U protocol entity per IP address.

The TEID in the GTP-U header is used to de-multiplex traffic incoming from remote tunnel endpoints so that it is delivered to the user plane entities in a way that allows multiplexing of different users, different packet protocols and different QoS levels. Therefore no two remote GTP-U endpoints shall send traffic to a GTP-U protocol entity using the same TEID value.

Exemplary embodiments of this invention provide in one aspect thereof a packet switcher function for packet flow switching to two different radios, for example an LTE radio and a Wi-Fi radio. The switching functionality is able to switch packets of a packet flow to either one of the LTE or Wi-Fi radios at a time or both LTE and Wi-Fi radio at the same time (i.e., packet level switching). The exemplary embodiments of this invention provide in another aspect thereof an ability for the switching functionality to decide based on the packet flow, which of the radio transports (for example LTE transport or Wi-Fi transport) to use for that flow. The two radios may be used simultaneously to serve parallel packet flows.

The exemplary embodiments of this invention thus provide the packet switcher functionality, for example between a RLC layer and MAC layer, to handle packet flows over the LTE and Wi-Fi radios, for example. This is a significant advancement over conventional approaches where the packet flows are handled separately in a gateway.

The packet flow switching in the packet switching function may allow transparent operation item the IP stack point of view as only one IP address needs to be assigned in the GGSN/PGW regardless of the use of the two radios. The new functionality in accordance with the embodiments of this invention includes, but need not be limited to: switching decisions within the packet switcher function.

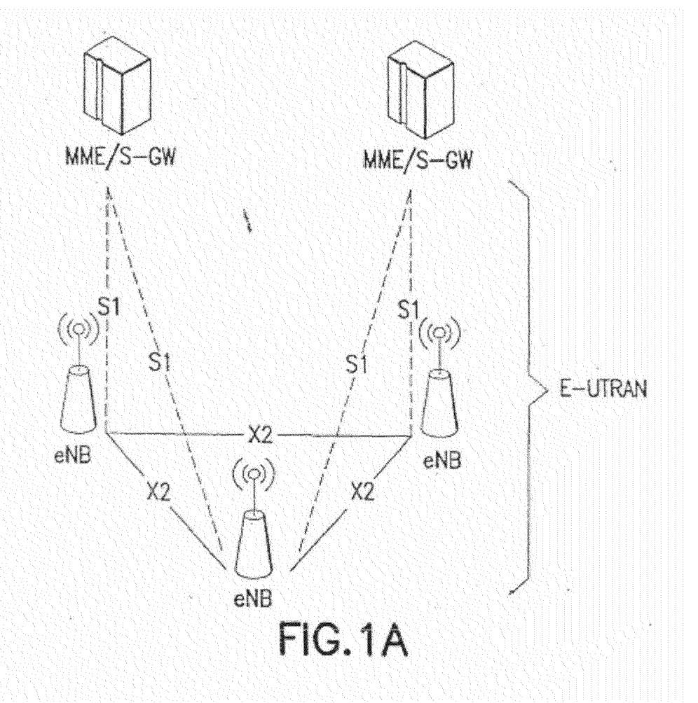

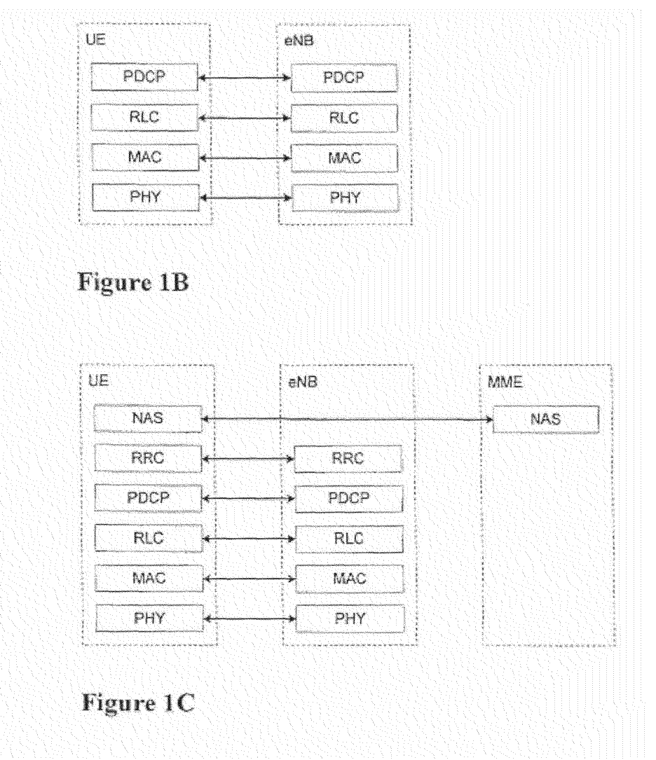

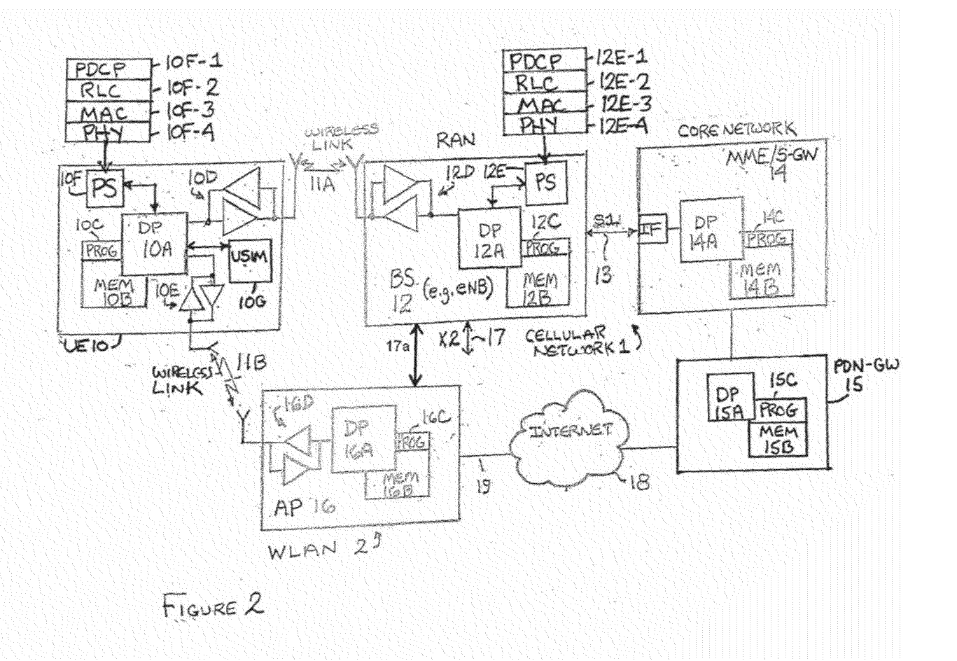

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a first wireless link 11A with an apparatus, such as a mobile communication device which may be referred to as a UE 10, via a network access node, such as a Node B (base station), and more specifically an eNB 12. The wireless network 1 can be implemented as a cellular wireless network, and in some embodiments can be compliant with LTE/LTE-A. The network 1 includes a core network that can include the MME/S-GW 14 functionality; shown in FIG. 1A, and which provides connectivity with a further network, such as a telephone network, and/or a data communications network (e.g., the internet).

The UE 10 includes a controller, such as at least one computer or a data processor (DP) 10A, which may be for example a processor comprising at least one processing core, at least one non-transitory computer-readable memory medium embodied as a memory (MEM) 10B that stores a program of computer instructions (PROG) 10C, and at least one suitable radio frequency (RF) radio transmitter and receiver pair (transceiver) 10D for bidirectional wireless communications with the eNB 12 via one or more antennas. The memory may store computer program, code for controlling the functioning of UE 10 when the computer program code is run by the data processor.

FIG. 2 also shows a WLAN network 2 that Includes at least one access point (AP) 16, and the UE 10 has at least one further radio transmitter and receiver pair (transceiver) 10E for bidirectional wireless communications with the AP 16 via one or more antennas and a second wireless link 11B. In general, and as is well known, the Wi-Fi transport radio 10E carries IP/Ethernet packets. Note that the transceiver 10E can instead be compatible with a local area evolved 3GPP standard, or a transceiver separate from the WLAN transceiver 10E can be provided for this purpose.

Note also that the UE 10 could be referred to as a UE/STA 10, which implies a device that operates both as a UE of the 3GPP standard and as a STA (station) of the IEEE802.11 standard.

The eNB 12 also includes a controller, such as at least one computer or a data processor (DP0 12A, at least one computer-readable memory medium embodied as a memory (MEM) 12B that stores a program of computer instructions (PROG) 12C, and at least one suitable RF transceiver 12D for communication with the UE 10 via one or more antennas. The eNB 12 is coupled via a data/control path 13 to the MME/S-GW 14. The path 13 may be implemented as the S1 interface shown in FIG. 1A. The eNB 12 may also be coupled to another eNB via data/control path 17, which may be implemented as the X2 interface shown in FIG. 1A. In some embodiments there is an X2 interface 17 between the eNB 12 and the WiFi AP 16. In some other embodiments, there is disposed an eNB-AP interface 17a connecting eNB 12 and AP 16, wherein eNB-AP interface 17a is different from a X2 interface. Interface 17a may be, for example, a modified X2 interface, a proprietary interface or, as a further example, an internal bus in embodiments where eNB 12 and AP 16 are implemented in one physical unit.

The eNB 12 as well as the AP 16 may separately or jointly be referred to as a Home Evolved NodeB (HeNB), or an office access point, a wireless node, a hotspot, or by any similar names and designators, as examples.

The MME/S-GW 14 includes a controller, such as at least one computer or a data processor (DP) 14A, at least one non-transitory computer-readable memory medium embodied as a memory (MEM) 14B that stores a program of computer instructions (PROG) 14C, and at least one suitable interface (IF) 14D, such as one compliant with the S1 interface shown in FIG. 1A, fin conducting bidirectional communications with the eNB 12. The MME/S-GW 14 can be connected to the Internet 18 via a PDN gateway 15. This implementation of the S-GW separate from, or integrated into, the PDN gateway 15 is a design choice. Whether or not the S-GW is integrated into the PDN gateway 15 the PDN gateway 15 can be assumed to be similarly constructed to include at lease one data processor 15A connected with at least one memory 15B that stores computer-executable code 15C configures to control the PDN gateway, when run on processor 15A.

The AP 16 also includes a controller, such as at least one computer or a data processor (DP) 16A, at least one computer-readable memory medium embodied as a memory (MEM) 16B that stores a program of computer instructions (PROG) 16C, and at least one suitable RF transceiver 16D for communication with the UE 10 via one or more antennas. According to at least some embodiments of the present invention, the AP 16 is connected to the BS 12 with a new interface. The new interface could use some existing protocols, such as used e.g., in X2 interface, or be a separate interface such as 17a. The AP 12 may also be coupled via a path 19 to the Internet 18 typically via at least one gateway.

For the purposes of describing the exemplary embodiments of this invention the UE 10 can be assumed to also include a protocol stank (PS) 10F, and the eNB 12 also includes a protocol stack (PS) 12E. For the case where the eNB 12 is LTE and/or LTE-A compliant the PSs 10F and 12E can be assumed to implement the protocol stacks shown in FIGS. 1B and 1C, and thus include the PDCP layer 10F-1, 12E-1 and lower layers (RLC 10F-2, 12E-2, MAC 10F-3, 12E-3 and PHY 10F-4, 12E-4). The protocol stack may also comprise a packet switcher function disposed between the RFC and MAC protocol layers.

The UB 10 can also include a USIM 10G (e.g., see 3GPP TS 31.111 V10.4.0 (2011-10) Technical Specification 3^{rd} Generation Partnership Project; Technical Specification Group Core Network and Terminals; Universal Subscriber Identity Module (USIM) Application Toolkit (USAT) (Release 10), 3GPP TS 31.102 V11.0.0 (2011-10) Technical Specification 3^{rd} Generation Partnership Project; Technical Specification Group Core Network and Terminals; Characteristics of the Universal Subscriber identity Module (USIM) application (Release 11) or some other type of subscriber identity module or functionality.

At least the PROGs 10C and 12C are assumed in include program instructions that, when executed by the associated data processor 10A and 12A enable the device to operate in accordance with the exemplary embodiments of this invention, as will be discussed below in greater detail. That is, the exemplary embodiments of this invention may be implemented at least in part by computer software executable by me DP 10A of the UE 10 and/or by the DP 12A of the eNB 12, or by hardware, or by a combination of software and hardware (and firmware). The PSs 10F and 10E can be assumed to be implemented at least in part by computer software executable by the DP 10A of the UE10 and by the DP 12A of the eNB 12.

The various data processors, memories, programs, transceivers and interfaces depicted in FIG. 2 can all be considered to represent means for performing operations and functions that implement the several non-limiting aspects and embodiments of this invention.

In general, the various embodiments of the UE 10 can include, but are not limited to, cellular mobile devices, smartphones, communicators, tablets, laptops, pads, personal digital assistants (PDAs) having wireless communication capabilities, portable computers having wireless communication capabilities. Image capture devices such as digital cameras having wireless communication, capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B, 12B, 14B and 16B may be of any type suitable to the local technical environment and maybe implemented using any suitable data storage technology, such as semiconductor based memory devices, random access memory, read only memory, programmable read only memory, flash memory, magnetic memory devices and systems, optical memory devices and systems, fixed memory and removable memory. The data processors 10A, 12A, 14A and 16A maybe of any type suitable to the local technical environment, and may include one or more of general purpose computers, special purpose computers, microprocessors, digital signal processors (DSPs) and processors based on multi-core processor architectures, as non-limiting examples.

For convenience, in the following description the (RF) radio transmitter and receiver pair (transceiver) 10D can be referred to as the LTE radio 10D or the LTE transport radio 10D, and the radio transmitter and receiver pair (transceiver) 10E can be referred to as the WiFi radio 10E or the WiFi transport radio 10E. These radios are assumed to include all necessary radio functionality, beyond just the transmitter and receiver per se, such as modulators, demodulators and baseband circuitry as applicable. Also, the reference to an LTE radio implies either LTE (LTE Rel-8) or LTE-A (e.g., Rel. 9, or 10, or higher). Note that an LTE-A compliant radio device may he backward-compatible with LTE.

It is pointed out that a particular instance of the UE 10 could have multiple cellular radios of the same or different types (e.g., a UTRAN transport radio and an E-UTRAN transport radio). As such, in the following discussion it should be kept in mind that the exemplary embodiments of this invention are not limited for use with switching a packet flow between one cellular radio and a Wi-Fi radio, but could be used as well to switch a packet flow or flows between two or more-cellular radios, or between any of said cellular radios and the Wi-Fi radio 10E. Note that, in general instead of Wi-Fi the radio 10E could he a cellular radio, and the cellular radio could be UTRAN instead of E-UTRAN.

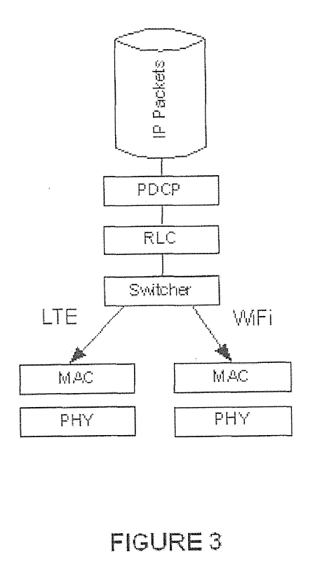

FIG. 3 illustrates an example protocol stack in accordance with at least some embodiments of the invention. The protocol stack(s) of FIG. 3 may be disposed in UE 10 or partly in eNB and AP, for example. Flows, each flow comprising a plurality of packets, arrive in the protocol stack from higher layers in the PDCP protocol layer. From the PDCP layer the packets are conveyed to the REC protocol layer. From the RLC protocol layer the packets arrive at the packet switcher function where decisions on switching the flows, or alternatively individual packets, are made. The packet switcher function is thus arranged to convey the packets or flows to the LTE and WiFi radios, respectively. In the illustrated example, both LTE and WiFi are furnished, with their own MAC layers, which feed the packets to the respective PHY, or physical, layers of the LTE and WiFi radios.

Alternatively the two radios may share a common MAC layer. The packets are transmitted over the LTE and WiFi air interfaces from the PHY protocol layers. In the illustration, LTE and WiFi are example radio access technologies. In general the packet switcher function may be configured to decide on switching packets or flows to at least two radio access technologies. Each radio access technology may have its own MAC and PHY protocol layers. In some embodiments, the switching doesn't take place between two radio access technologies. Rather, switching as described herein may take place between carriers comprised in an inter-site carrier aggregation.

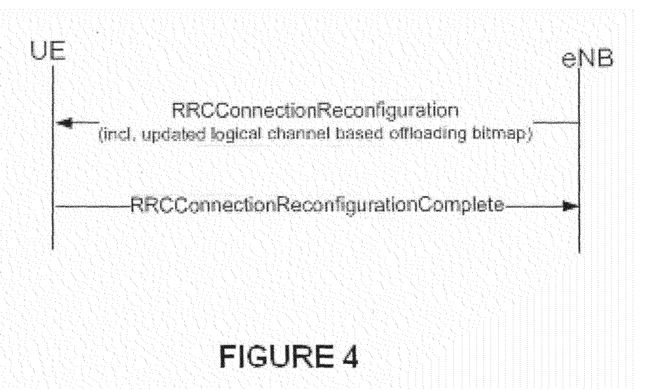

FIG. 4 illustrates signaling related to at least some embodiments of the invention. In the illustrated example embodiment, an LTE base station, known as eNB, configures an offloading bitmap to UE 10. The offloading bitmap may be conveyed to UE 10 in a RRCConnectionReconfigurationComplete message, for example. UE 10 may be configured to acknowledge successful receipt of the RRCConnectionReconfiguration message by transmitting an RRCConnectionReconfigurationComplete message back to the eNB, for example. UE 10 may be configured to provide the received offloading bitmap to the packet switcher function, for use by the packet switcher function in deciding on switching of packets or flows to a plurality of radio transceivers, each radio transceiver functioning in accordance with a different radio access technology, wherein each radio transceiver is comprised in UE 10. As an example, the bitmap may define which logical channels or flows may be routed via a certain radio access technology. For example, the bitmap may indicate with a “1” that a certain logical channel may be offloaded.

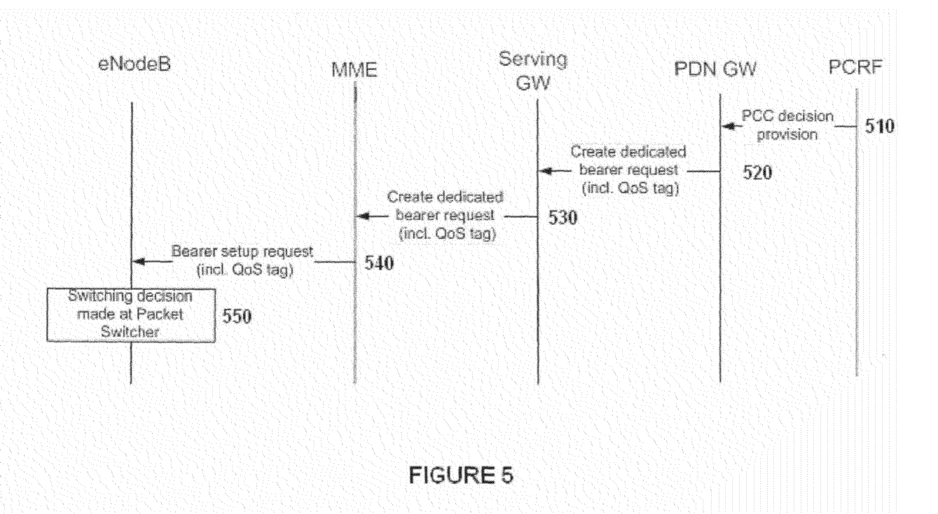

FIG. 5 illustrates signaling related to at least some embodiments of the invention involving a quality-of-service tag, or QoS tag. In phase 510, a PCRF node issues a decision concerning policies concerning at least one flow relating to UE 10. The decision maybe a policy and charging control, PCC, decision, for example. A PCC decision may comprise PCC rules and bearer attributes, for example. PCC rules may enable determining a data flow the decision applies to. A PCC role may comprise a service data flow template, for example, comprising parameters of a data flow. Responsive to receiving the PCC decision, a PDN GW may issue a QoS tag and transmit, in phase 520, a Create Dedicated Bearer Request toward a serving GW. In phase 530, responsive to receiving the Create Dedicated Bearer Request comprising the QoS tag, a Serving GW may transmit a Create Dedicated Bearer Request comprising the QoS Sag toward a MME. In phase 540, responsive to receiving the Create Dedicated Bearer Request comprising the QoS lag, a MME may transmit a Bearer Setup Request comprising the QoS tag toward an eNB. The QoS tag may be employed on a per-bearer or per-logical channel level to indicate whether the bearer or logical channel may be offloaded or not.

In general, there is provided a method comprising receiving packets of at least one flow in a packet switching function. The receiving may occur in UE 10, or in a base station node such as, for example, an eNB. Each of the at least one flow may comprise a plurality of packets sent in sequence. The method may also comprise deciding, in the packet switching function, based on at least one criterion, on switching packets received in the packet switching function to one or both of a cellular transport radio and a wireless local area network transport radio.

In some embodiments, the packet switching function is disposed in a protocol stack between a radio link control protocol layer and a medium access control protocol layer.

Being disposed between a radio link control protocol layer and a medium access control protocol layer may comprise that the packet switching function is attached to the end of the radio link control protocol layer, the beginning of the medium access control protocol layer, or that it is separate from the radio link control protocol layer and the medium access control protocol layer, in embodiments where the packet switching function is located at the beginning of the medium access control protocol layer, the medium access control protocol layer may obtain from the packet switching function information relating to which radio to be used for data transmission. Then the medium access control protocol layer may be configured to request from the radio link control protocol layer for a segmentation of data that is suitable for the wireless local area network transport radio if the segmented packet is to be transmitted over the wireless local area network transport radio. In this embodiment, the packet switching function may also be considered as part of the scheduling function of the MAC layer. If the switching function is part of the MAC scheduling function, the scheduler can use information from the wireless local area network transport radio in a similar as the scheduler uses the information from the cellular access transport radio, e.g., information about the available transport block size. This information can be used in the scheduler to request proper segmentation of RLC SDUs. The segmentation is a standard RLC functionality described in standard TS 36,222 published by 3GPP.

Where the packet switching function is comprised in a UE 10, deciding to switch packets to a wireless local area network transport radio may comprise sending the packets to a medium access control protocol layer of a wireless local area network transport radio comprised in the UE 10.

Where the packet switching function is comprised in a base station node, deciding to switch packets to a wireless local area network transport radio may comprise sending the packets to a wireless local area network transport radio comprised is the base station or operably connected to the base station. The packets may be conveyed from the base station node to the wireless local area network transport radio by means of interface 17 or interlace 17a, for example.

In some embodiments, both UE 10 and a base station node UE 10 is attached to comprise packet switcher function. In the embodiments, the packet switcher functions may be configured to switch flows and/or packets using similar, or even the same, at least one criterion. The packet switcher functions may be so configured, for example, when a network node other than the base station provides the at least one criterion to the base station as described above in connection with FIG. 5, and the base station in turn provides the at least one criterion to UE 10.

In some embodiments, the cellular transport radio comprises a long term evolution, LTE, radio. In some embodiments, the wireless local area network transport radio comprises a transport radio compliant with an IEEE 802.11 standard.

In some embodiments, the method comprises receiving in the packet switching function switching information indicating explicitly or implicitly which packets may be switched to the wireless local area fretwork transport radio. The switching information may indicate which kind of packets may be so switched, or the switching information may indicate which flows, or which kind of flows, may be so switched. When flows are indicated or described, the indication may apply to at least a part of packets comprised in the indicated or described flow. In some embodiments, where a flow or logical channel is indicated or described as suitable for switching to the wireless local area network transport radio, the packet switching function is configured to switch some, but not all packets of these flows to the wireless local area network transport radio. In some embodiments, where a flow or logical channel is indicated or described as suitable for switching to the wireless local area network transport radio, the packet switching function is configured to switch ail packets of these flows to the wireless local area network transport radio.

In some embodiments, the at least one criterion comprises the switching information. In other words, the decisions on switching may be based at least in part on the received switching information.

In some embodiments, the at least one criterion comprises the switching information and local packet inspection. In other words, the decisions on switching may be based at least in part on the received switching information applied together with local packet inspection. For example, where the switching information describes what kind of packets may be routed to the wireless local area network transport radio, the packet switching function may compare packets it receives to the switching information, or parameters derived from the switching information, to decide on whether to switch the packets to the cellular transport radio or the wireless local area network transport radio. The decisions may be taken on a per-packet basis or on a per-flow basis. Subsequent to deciding that a first flow may be routed via the wireless local area network transport radio, the packet switcher function may be configured to switch packets to the wireless local area network transport, radio responsive to determining that they am comprised in the first flow. In some embodiments, responsive to deciding that a flow or logical channel is suitable for switching to the wireless local area network transport radio, the packet switching function is configured to use local packet inspection to inspect packets comprised in the flow or logical channel and decide, which packets from among packets comprised in the flow or logical channel traffic will be switched to the wireless local area network transport radio. Alternatively or in addition to local packet inspection, packets comprised in a flow or logical channel suitable for switching to the wireless local area network transport radio may be decided to be switched to the wireless local area network transport radio depending on at least one of prevailing radio conditions and prevailing congestion. In other words, the current level of congestion and/or the current radio conditions may affect the switching decisions, either alone or in combination with local packet inspection.

Radio conditions may comprise, for example, fading, pathless or wireless channel type. Prevailing congestion may comprise, for example, a delay or time it takes for a packet to traverse a node or set of nodes in a given roots, such as an eNB+MME route or AP+gateway route.

In some embodiments, the switching information is comprised of a bitmap received from a network node. Where the packet switching function is comprised in UE 10, the bitmap may be received from a base station node. Where the packet switching function is comprised in a base station node, the bitmap may be received from a base station controller, or a MME, for example. The bitmap may indicate with “1” or “0” which flows may be switched to the wireless local area network transport radio, for example. The packet switching function may be configured to switch packets to the wireless local area network transport radio responsive to determining that they are comprised in a first flow indicated in the bitmap as a flow that is allowed to be switched to the wireless local area network transport radio. In some embodiments, the packet switching function is configured to use the bitmap to determine which flows or logical channels are offloadable, and decide separately concerning each packet comprised in the offloadable flows or logical channels on switching each packet. Flows that are indicated in the bitmap as not offloadable may be switched to the cellular system without per-packet decisions.

In some embodiments, the switching information comprises a flow-specific indication as to whether the flow may be switched to the wireless local area network transport radio. Where the packet switching function is comprised in UE 10, the indication may be received from a base station node. Where the packet switching function is comprised in a base station node, the indication may be received from a base station controller, or a MME, for example. The decision on whether the flow may be so switched may be taken in a network entity, such as for example a PCRF or PDN GW, responsive to a request to establish the flow or the decision may be taken in the MMF or the base station. The indication may be forwarded to a base station and/or UE 10 along with a response to the request, the response authorizing the establishment of the flow. The indication may be a QoS tag or a new information element within the response message, for example. The indication may be, for example, a new information element in a RRCReconfigurationRequest message when setting up or reconfiguring a radio bearer or logical channel.

In general, switching information may be dynamically updated by signaling in dependence of communication parameters and/or network configuration, for example.

In some embodiments, the at least one criterion comprises at least one of a priority and a priority range. The packet switching function may in these embodiments be configured to compare a priority of an arriving flow or packet to switching information defining which priority or priorities may be switched to the wireless local area network transport radio. For example, where a priority range is defined in the switching information, the packet switching function may be configured to switch a flow or packet to the wireless local area network transport radio responsive to determining that a priority of the flow or packet is comprised in the priority range indicated in the switching information. The priority range for switching to the wireless local area network transport radio can be dynamically changed based on WLAN load, for example.

Where the packet switching function is comprised in UE 10, information defining the priority or priority range may be received in UE 10 from a base station node. Where the packet switching function is comprised its a base station node, information defining the priority or priority range may be renewed in the base station node from a network node, such as for example a gateway.

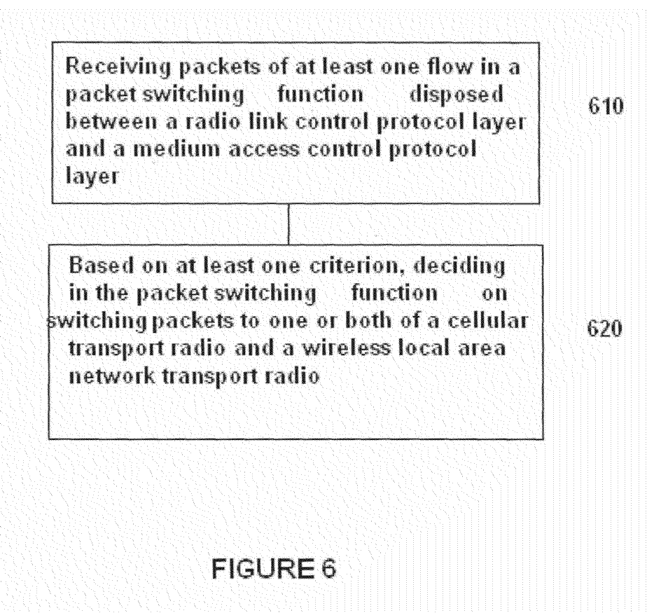

FIG. 6 is a flow diagram of a method in accordance with at least some embodiments of the invention. Phase 610 comprises receiving packets of at least one flow in a packet switching function, for example one disposed between a radio link control protocol layer and a medium access control protocol layer. The receiving may occur in a protocol stack of UE 10, or alternatively in a base station node such as, for example, an eNB. Each of the at least one flow may comprise a plurality of packets sent in sequence. Phase 620 comprises deciding, in the packet switching function, based on at least one criterion, on switching at least one of the packets received in the packet switcher function to one or both of a cellular transport radio and a wireless local area network transport radio.

In another embodiment, the transport over the LTE transport radio forms a radio bearer, and the transport over the Wi-Fi transport radio forms a radio bearer, and the radio bearers are mapped within at least one protocol layer or function, such as for example the packet switcher function, to the same EPS bearer. Alternatively, the same radio bearer or logical channel is used over both radios, only the MAC and physical layers being different.

If the same EPS bearer is used for both LTE and Wi-Fi transport, the EPS bearer requirements should be met by both radios 10D and 10E. In this case the packets of the LTE radio 10D and the packets of the Wi-Fi radio 10E may be tunneled, to the same GTP-u tunnel. In this case the handover from the eNB 12/AP 16 to another eNB 12 may be a common procedure with common path switching. It is possible that in the target eNB 12 the EPS bearer is served by a LTE radio bearer only. Since the EPS bearer is common, the packet switching function needs to be able to route traffic from/to a single EPS hearer from two different radio bearers. This is basically a switching functionality and does not impose specific constraints, other than, in some embodiments, accommodating for example the different Block Error Rate (BLER) and delay characteristics of the two radios 10D, 10E.

There are a number of advantages that can be realized by the use of the described exemplary embodiments of this invention. For example, tight integration of the Wi-Fi transport radio to LTE enables better coordination of the use of the LTE and Wi-Fi radios 100, 10E, allows offloading to occur in an efficient manner, enables use of unlicensed spectrum and enables power efficient device operation. An additional advantage that is gained is faster packet flow switching between radios and also more efficient and less complex handover procedures. The impact of LTE and Wi-Fi operation at the network side can be reduced as compared to conventional offloading by IP flow mobility procedures. Furthermore, the exemplary embodiments enable the use of the two radios for radio interface offloading in a manner that is transparent to the UE 10 and the network IP connectivity layer. That is, there is no need to assign separate IP addresses for the WiFi flows and LTE flows, as is the case with some conventional offloading approaches from LTE Rel-8 and onwards. An advantage of switching below the RLE layer is that ARQ can be used for reliable transmission on top of any layer-1, L1, schemes. In some embodiments, packet switching may be concealed from a core network, simplifying and rendering more dynamic the offloading of packets to a wireless local area network transport radio.

Based on the foregoing it should be apparent that the exemplary embodiments of this invention provide a method, apparatus and computer program(s) to enable an efficient use of a cellular and a Wi-Fi radio of a device to at least enable efficient flow switching and offloading of cellular packet traffic.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the invention may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN, LTE, LTE-A and IEEE 802.11 type systems it should be appreciated that the exemplary embodiments of this invention are not limited for use with only these particular types of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements maybe considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names. Further, the various names assigned to different devices, bearers, interfaces, protocol stack layers, PDCP functionalities, entities and the like are not intended to be limiting in any respect, as these various devices, bearers, interfaces, protocol stack layers, PDCP functionalities and entities may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
receiving packets of at least one flow in a packet switching function disposed in a protocol stack between a radio link control protocol layer and a medium access control protocol layer;
receiving in the packet switching function switching information indicating which packets may be switched to a wireless local area network transport radio, and
based on at least one criterion, deciding in the packet switching function on switching the packets to one or both of a cellular transport radio and a wireless local area network transport radio, wherein the at least one criterion comprises the switching information.

2. (canceled)

3. A method according to claim 1, wherein the at least one cellular transport radio is compliant with a long term evolution (LTE) standard and the wireless local area network transport radio is compliant with at least one of an IEEE 802.11 (Wi-Fi) standard or a local area evolved 3GPP standard.

4. (canceled)

5. (canceled)

6. A method according to claim 1, further comprising deciding, in the packet switching function, based on the switching information and at least one of local packet inspection, prevailing radio conditions and prevailing congestion, whether to switch packets of a flow to the wireless local area network transport radio.

7. A method according to claim 1, wherein the switching information is comprised in a bitmap indicating which flows or logical channels may be switched to the wireless local area network transport radio.

8. A method according to claim 7, comprising receiving the bitmap from a base station.

9. A method according to any claim 1, wherein the switching information is comprised in a flow-specific indication received from a network node.

10. A method according to claim 1, wherein the at least one criterion comprises at least one of a priority or a range of priorities.

11. A method according to claim 10, wherein information defining the priority or range of priorities is received from a base station.

12. An apparatus, comprising:
at least one data processor; and
at least one memory including computer program code, where the at least one memory and computer program code are configured, with the at least one data processor, to cause the apparatus at least to:
receive packets of at least one flow in a packet switching function disposed in a protocol stack between a radio link control protocol layer and a medium access control protocol layer;
receive in the packet switching function switching information indicating which packets may be switched to a wireless local area network transport radio, and
based on at least one criterion, decide in the packet switching function on switching the packets to one or both of a cellular transport radio and a wireless local area network transport radio, wherein the at least one criterion comprises the switching information.

13. (canceled)

14. An apparatus according to claim 13, wherein the packet switching function is disposed at a beginning of a medium access control protocol layer, and the packet switching function is configured to request from the radio link control protocol layer a segmentation of data, wherein the request comprises information describing the requested segmentation.

15. An apparatus according to claim 12, where the at least one cellular transport radio is compliant with a long term evolution (LTE) standard and the wireless local area network transport radio is compliant with at least one of an IEEE 802.11 (WiFi) standard or a local area evolved 3 GPP standard.

16. (canceled)

17. (canceled)

18. An apparatus according to claim 12, further comprising deciding, in the packet switching function, based on the switching information and at least one of local packet inspection, prevailing radio conditions and prevailing congestion, whether to switch packets of a flow to the wireless local area network transport radio.

19. An apparatus according to claim 12, wherein the switching information is comprised in a bitmap indicating which flows or logical channels may be switched to the wireless local area network transport radio.

20. An apparatus according to claim 19, comprising receiving the bitmap from a base station.

21. An apparatus according to claim 12, wherein the at least one criterion comprises at least one of a priority or a range of priorities.

22. An apparatus according to claim 21, wherein information defining the priority or range of priorities is received from a base station.

23. A non-transitory computer readable medium having stored thereon a set of computer readable instructions that, when executed by at least one processor, cause an apparatus to at least:
receive packets of at least one flow in a packet switching function disposed in a protocol stack between a radio link control protocol layer and a medium access control protocol layer;
receive in the packet switching function switching information indicating which packets may be switched to a wireless local area network transport radio, and
based on at least one criterion, decide in the packet switching function on switching the packets to one or both of a cellular transport radio and a wireless local area network transport radio, wherein the at least one criterion comprises the switching information.
